(19) United States
(12) Patent Application Publication
(10) Pub. No.: US 2010/0192710 A9
(43) Pub. Date: Aug. 5, 2010

(54) Sheet conveying device and image forming apparatus

(75) Inventors: Toru Hanashima, Ibaraki (JP); Hiroshi Fujiwara, Osaka (JP); Haruyuki Honda, Ibaraki (JP); Yasuhide Ohkubo, Osaka (JP); Tatsuo Fukushima, Osaka (JP); Kimihiro Tanaka, Osaka (JP)

Correspondence Address: Harness, Dickey & Pierce P.L.C., P.O. Box 8910, Reston, VA, 20195, US

(73) Assignee: RICOH COMPANY, LIMITED

(21) Appl. No.: 12/230,734

(22) Filed: Sep. 4, 2008

(30) Foreign Application Priority Data
Sep. 4, 2007 (JP) 2007-228787

(51) Int. Cl. F16H 25/14

(52) U.S. Cl. 74/55

(57) ABSTRACT

Plural auxiliary rotating members abut at different positions in a circumferential direction of a roller-shaped rotating member that is configured to rotate in a forward direction and a reverse direction. Diameters of a portion of the roller-shaped rotating member where a first auxiliary rotating member abuts and a portion of the roller-shaped rotating member where a second auxiliary rotating member abuts are different from each other. Conveying speeds of sheets conveyed by the first auxiliary rotating member and the second auxiliary rotating member with the roller-shaped rotating member in different directions at the same time are different from each other.

### CROSS-REFERENCE TO RELATED APPLICATIONS

The present application claims priority to and incorporates by reference the entire contents of Japanese priority document 2007-228787 filed in Japan on Sep. 4, 2007.

### BACKGROUND OF THE INVENTION

1. Field of the Invention

The present invention relates to a sheet conveying device that conveys sheet such as paper using a roller-shaped rotating member such as a roller and an image forming apparatus equipped with the sheet conveying device.

2. Description of the Related Art

With typical electro-photographic method image forming apparatus, a latent image is formed on a photosensitive member. The latent image is then developed using toner. The developed toner image is then transferred to a recording medium such as paper either directly or via an intermediate transfer member. The image is then fixed to the recording medium using heat (and pressure). The latent image, image, and recording medium are typically conveyed by rotating respective roller-shaped rotating members. A drive source such as a motor is provided to rotate the rollers. Coupling then takes place as far as the roller-shaped rotating members using a drive transmission mechanism such as a gear or a timing belt.

The diameters etc. of each of the roller-shaped rotating members are set to appropriate values so that the recording medium is not subjected to sagging or tensioning to a greater extent than is necessary as a result of recording medium conveying force of the roller-shaped rotating members sandwiching and tensioning the recording medium while conveying the recording medium. An appropriate value is typically set for the recording medium conveying at the time when the recording medium is at the roller-shaped rotating member.

During duplex printing of a recording medium, there are two recording medium conveying paths for when the recording medium fixed with the image is discharged to outside. Equipment is then widely adopted having a mechanism where the recording medium is reversed within the machine to print to the other surface of the recording medium while discharging the recording medium to outside. Such equipment has been disclosed in Japanese Patent Application Laid-open No. H8-59046 and Japanese Patent Application Laid-open No. H6-250463. It is typical for the discharge roller to be rotated forwards and in reverse so that parts can be common for the conveying of the recording medium. Such a discharge roller is shown in Japanese Patent Application Laid-open No. 2006-017988.

However, a separate conveying unit is usually required to convey the recording medium to the respective paths on the downstream side in the conveying direction of the recording medium in the vicinity of a divergence point of the recording medium conveying paths. This increases the number of parts. Such a situation is shown in Japanese Patent Application Laid-open No. H8-59046 and Japanese Patent Application Laid-open No. H6-250463.

On the other hand, when the discharge roller is made to go in forwards and reverse so that conveying for reversing the recording medium can adopt the same number of parts to reduce the number of parts, the recording medium is reversed after one side of the recording medium is printed. It is therefore not possible to print the next recording medium until the reverse surface is printed and discharged. This reduces the number of pages that can be printed per unit time. Such a situation is disclosed in Japanese Patent Application Laid-open No. 2006-017988.

A structure is also well-known where discharging and reversing of the recording medium can take place at the same time by installing two rotated auxiliary rollers that abut with the discharge roller and reversing the orientation of the recording medium conveying direction at each respective point of contact in order that reverse printing can also take place during reversing of the recording medium. Here, a recording medium conveying speed the recording medium is discharged by the discharge roller at is to be set so that the recording medium is not subjected to sagging or tensioning to a greater extent than is necessary between a discharge unit and a fixing unit upstream from the discharge unit. However, in this structure the reverse conveying speed of the recording medium is equal to an arbitrary discharge speed. The time required to reverse the conveying of the recording medium therefore cannot be made shorter other than by shortening the reverse conveying path length.

Technology also exists that reduces size and price by performing paper discharge and reversal at one location using three rollers. There is also technology for increasing productivity during duplex printing by discharging and reversing two pieces of paper at the same time using three rollers (one piece of paper is reversed while the other piece of paper is discharged).

However, with this image forming apparatus, printing productivity is improved by making the speed for the reverse path as fast as possible regardless of the transferring. However, when there are three rollers as in the art, one roller is used for both discharging and reversing. The speeds of discharging and reversing are therefore always the same. This means that productivity cannot be improved during reversing and discharging of two pieces of paper at the same time.

### SUMMARY OF THE INVENTION

It is an object of the present invention to at least partially solve the problems in the conventional technology.

According to an aspect of the present invention, there is provided a sheet conveying device that is configured to convey a sheet in different directions at a time. The sheet conveying device includes a roller-shaped rotating member that is rotated by a driving force from a drive unit; and a plurality of auxiliary rotating members including a first auxiliary rotating member and a second auxiliary rotating member, abutting at different positions in a circumferential direction of the roller-shaped rotating member. The roller-shaped rotating member is configured to rotate in a forward direction and a reverse direction. A diameter of a first portion of the roller-shaped rotating member where the first auxiliary rotating member abuts and a diameter of a second portion of the roller-shaped rotating member where the second auxiliary rotating member abuts are different from each other. A conveying speed of a sheet conveyed in a first nip formed by the first auxiliary rotating member and the roller-shaped rotating member and a conveying speed of a sheet conveyed in a second nip formed by the second auxiliary rotating member and the roller-shaped rotating member in different directions at a time are different from each other.

Furthermore, according to another aspect of the present invention, there is provided an image forming apparatus including a sheet conveying device that includes a roller-shaped rotating member that is rotated by a driving force from a drive unit; and a plurality of auxiliary rotating members including a first auxiliary rotating member and a second auxiliary rotating member, abutting at different positions in a circumferential direction of the roller-shaped rotating member. The roller-shaped rotating member is configured to rotate in a forward direction and a reverse direction. A diameter of a first portion of the roller-shaped rotating member where the first auxiliary rotating member abuts and a diameter of a second portion of the roller-shaped rotating member where the second auxiliary rotating member abuts are different from each other. A conveying speed of a sheet conveyed in a first nip formed by the first auxiliary rotating member and the roller-shaped rotating member and a conveying speed of a sheet conveyed in a second nip formed by the second auxiliary rotating member and the roller-shaped rotating member in different directions at a time are different from each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a cross-sectional view of an outline of a color printer that is an example of an image-forming apparatus equipped with a sheet conveying device of the present invention;

FIG. 2 is an enlarged diagram of the vicinity of a discharging/reversing unit of the printer;

FIG. 3 is a perspective view of essential parts of a paper conveying device according to a first embodiment of the present invention;

FIG. 4 is a schematic drawing illustrating the operation of a discharging/reversing unit;

FIG. 5 is a schematic drawing explaining drive control of a paper conveying device according to the first embodiment of the present invention;

FIG. 6 is a perspective view of a second embodiment of a paper conveying device according to the present invention;

FIG. 7 is a side view of a third embodiment of a paper conveying device according to the present invention; and

FIG. 8 is an enlarged diagram showing an example of a drive system for a paper conveying device and shows the vicinity of a discharging/reversing unit.

### DETAILED DESCRIPTION OF THE PREFERRED EMBODIMENTS

Exemplary embodiments of the present invention are explained in detail below with reference to the accompanying drawings.

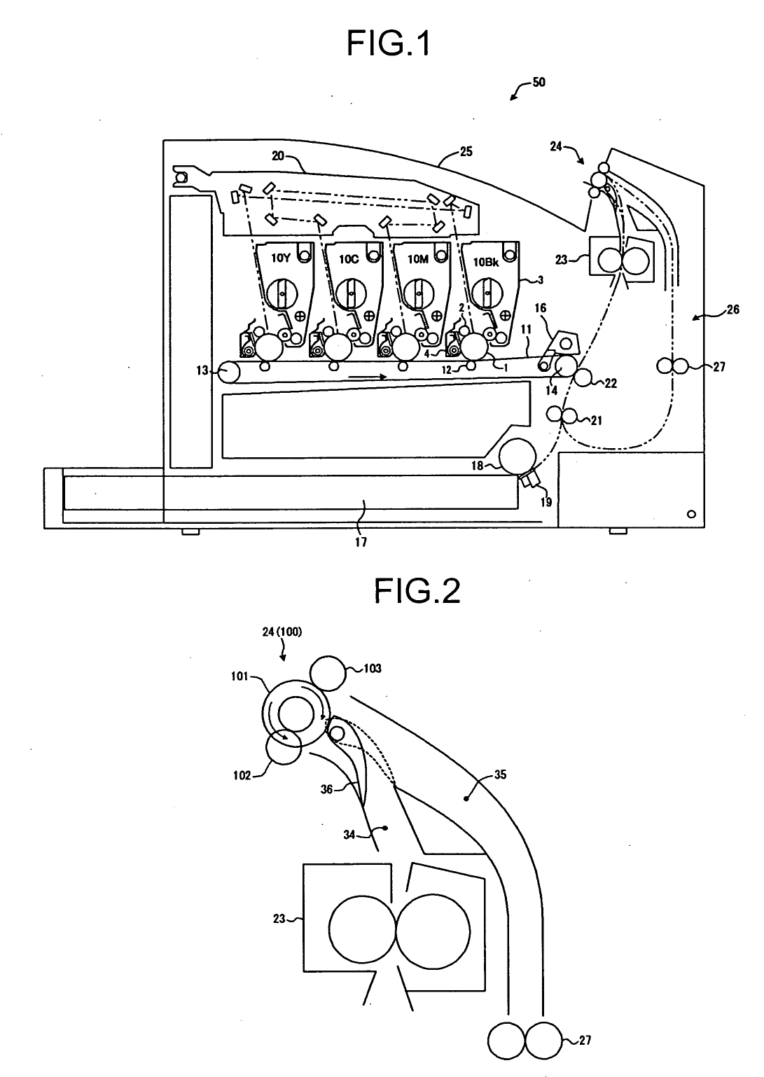

FIG. 1 is a cross-sectional view showing an outline of a color printer that is an example of an image forming apparatus equipped with a sheet conveying device of the present invention. A color printer 50 shown in the drawing is a color printer adopting a tandem method that is capable of forming full-color images. Four image-forming units 10 (Y, C, M, Bk) are disposed at a substantially central part of the device body. Each image-forming unit 10 (Y, C, M, Bk) is lined up along an upper conveying edge of an intermediate transfer belt 11. The intermediate transfer belt 11 wrapped around the support rollers 13, 14 is driven to be conveyed in an anti-clockwise direction in the drawings. A cleaning unit 16 that cleans the intermediate transfer belt 11 is disposed at the transfer opposing roller 14 that is a support roller for the right side.

Toner colors handled by each image-forming unit 10 are different but the structure is the same. Photosensitive drums 1 are provided as image carriers. A charging unit 2, developing apparatus 3, and a cleaning unit 4 are disposed about the photosensitive drums 1. Transfer rollers 12 are provided as primary transfer units on the inside of the intermediate transfer belt 11 so as to face each photosensitive drum 1. To keep the drawings simple, numerals for each item of equipment constituting the image-forming unit are only given to unit 10Bk that is the image-forming unit for the color black, and are omitted for image-forming units of other colors.

An optical writing unit 20 is provided above the four image-forming units 10. The optical writing unit 20 has a polygon mirror and a mirror group etc. and modulated laser light is irradiated onto the photosensitive drums 1 of the image-forming units for each color.

A paper feed tray 17 loaded with paper is disposed at the lower part of the device body. A paper feed roller 18 that sends out paper loaded at the paper feed tray 17 is provided at the right side of the paper feed tray 17. A separation pad 19 that separates the paper one sheet at a time is pressure-fused at the paper feed roller 18. Paper stop rollers 21 are provided above the paper feed roller 18 and the separation pad 19 (on the downstream side in a paper conveying direction). A transfer roller 22 taken as a secondary transfer unit is provided above the paper stop rollers 21 facing the transfer opposing roller 14 so as to form a secondary transfer unit.

A fixing unit 23 is provided above the secondary transfer unit. The fixing unit 23 includes a fixing roller and a pressure roller. Paper that the unfixed toner images have been transferred to is then fixed at the secondary transfer unit by heating and applying pressure to the transferred paper. A paper discharging/reversing roller 24 is provided above the fixing unit 23. Paper after fixing is then discharged onto a copy receiving tray 25 formed at the upper surface of the device.

A duplex conveying unit 26 is provided at the right side of the device in the drawing. When duplex printing is carried out, paper with images formed on a surface is passed through the fixing unit 23. The paper is then switched back by the paper discharging/reversing roller 24 and sent to the duplex conveying unit 26. The front and reverse surfaces are then reversed and the paper is again fed to the paper stop rollers 21. A pair of conveyor rollers 27 is disposed at the duplex conveying unit 26.

A brief description is now given of an image-forming operation occurring at the color printer 50 constructed in the above manner. The photosensitive drums 1 of the image-forming units 10 are rotated in a clockwise direction in the drawings by a drive unit (not shown). Laser light from the optical writing unit 20 is irradiated onto charged photosensitive surfaces. This causes latent images to be formed on the surfaces of the photosensitive drums 1. At this time, image information exposed at each of the photosensitive drums 1 is unitary color image information where a desired full color image is broken down into color information of yellow, magenta, cyan, and black. Toner for each color is provided from the developing apparatus 3 to the electrostatic latent images formed in this manner so as to make the latent images visible as toner images.

The intermediate transfer belt 11 is driven in an anti-clockwise direction in the drawings. Toner images for each color are then transferred so as to be sequentially overlaid from the photosensitive drums 1 at the intermediate transfer belt 11 as a result of the action of the transfer rollers 12 at each image-forming unit 10. A full-color toner image is therefore supported at the surface of the intermediate transfer belt 11.

It is therefore possible to use just one of the image-forming units 10 to form a single color image, or to form images using two or three colors. Images are formed using just the unit Bk furthest to the right side of the drawing of the four image-forming units during monochrome printing.

Residual toner affixed to the surface of the photosensitive drum after transfer of a toner image is then removed from the surface of the photosensitive drum by the cleaning unit 4. The surface is then subject to the action of a charge remover, surface potential is initialized, and the next image is formed.

On the other hand, paper is fed from the paper feed tray 17. The paper is then sent to a secondary transfer position by the pair of paper stop rollers 21 while ensuring that the timing coincides with the toner images supported on the intermediate transfer belt 11. In this example, a transfer voltage of a reverse polarity to the toner electrification polarity of the toner images at the surface of the intermediate transfer belt is applied to the secondary transfer roller 22. As a result, toner images at the surface of the intermediate transfer belt are collectively transferred onto the paper. When the paper toner images are transferred to pass through the fixing unit 23, the toner images are fused to the paper using heat and pressure. The fixed paper is then discharged to the copy receiving tray 25 formed on the upper surface of the device body by the paper discharging/reversing roller 24.

During duplex printing, the paper with a toner image fixed on one side is switched back by the paper discharging/reversing roller 24 and sent to the duplex conveying unit 26. The front and reverse sides of the paper are then reversed and the paper is fed again to the pair of paper stop rollers 21. A toner image is then transferred from the intermediate transfer belt 11 to the reverse surface of the re-fed paper. The reverse surface image is then fixed at the fixing unit 23. Duplex printing is then completed by discharging the paper supporting the image at the front and reverse surfaces to the copy receiving tray 25.

At the color printer 50 of this example, when duplex printing is carried out consecutively for a plurality of pieces of paper, the preceding paper (paper for which printing of one side is complete) is sent to the duplex conveying unit 26. While the preceding paper is being reversed, subsequent paper or reversed paper is printed. It is therefore possible to prevent lowering of productivity during consecutive duplex printing.

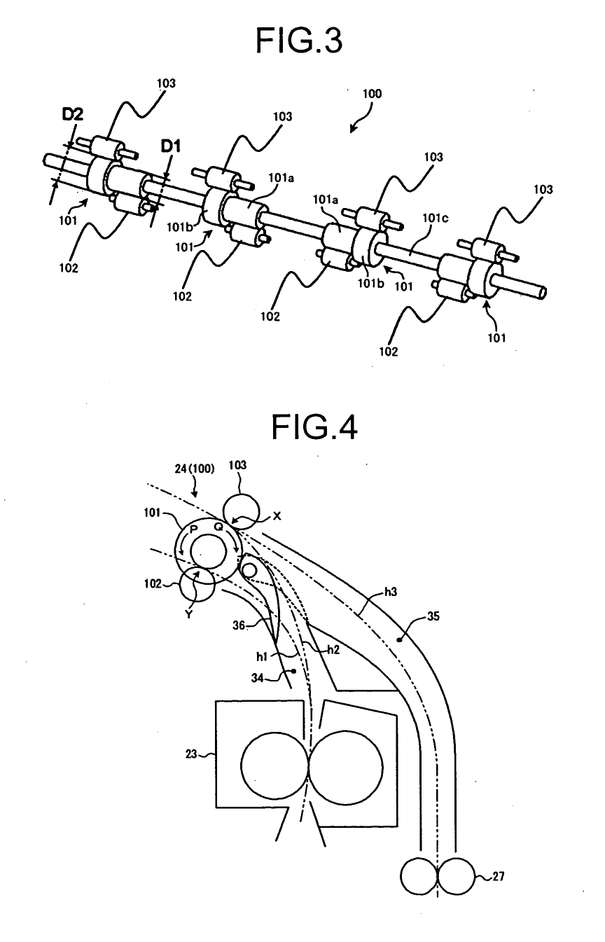

FIG. 2 is an enlarged view of the vicinity of the discharging/reversing unit. FIG. 3 is a perspective view showing essential parts of the first embodiment of the paper conveying device of the present invention. As shown in FIG. 2, a paper conveying device 100 taken as the paper discharging/reversing roller 24 includes a two-stage roller 101 (roller-shaped rotating member) capable of being rotated in both forward and reverse directions by a drive source (not shown), a paper discharge auxiliary roller 102 (one auxiliary rotating member) abutting with the two-stage roller 101 and rotated by the two-stage roller 101, and a paper reversing auxiliary roller 103 (other one auxiliary rotating member) abutting with the two-stage roller 101 at a different position to the paper discharge auxiliary roller 102 and rotated by the two-stage roller 101.

Two paper conveying paths, a first conveying path 34 linking with the fixing unit 23 and a second conveying path 35 linking with the duplex conveying unit 26, are formed taking the vicinity of the two-stage roller 101 as a divergence point. A switching unit 36 that switches between the paper conveying paths is then installed at this divergence point. The switching unit 36 is provided at a position so as to be moveable between a depiction of the switching unit 36 using a solid line and that using a virtual line. The forward and reverse rotation of the two-stage roller 101 and a reciprocating operation of the switching unit 36 are typically enacted by forward and reverse rotation of a drive source such as a motor or by the action of a reciprocating action generating unit such as a solenoid.

As shown in FIG. 3, the two-stage roller 101 of the paper conveying device 100 is split-level with differing diameters of D1 and D2 (D1<D2) . The paper discharge auxiliary roller 102 abuts with the upper periphery of a small diameter section 101a having a diameter D1 and the paper reversing auxiliary roller 103 abuts with the periphery of a large diameter section 101b having a diameter D2. In this example, four two-stage rollers 101 are fixed at a shaft 101c so as to constitute a drive roller.

The operation of the discharging/reversing unit is explained with reference to FIG. 4. During single-side printing, after passing through the fixing unit 23, the paper is discharged by the paper discharging/reversing roller 24 as is to the copy receiving tray 25 (FIG. 1). The switching unit 36 then switches over to the position denoted by the virtual line. The two-stage roller 101 is then rotated in the direction of an arrow Q. The paper therefore passes through the first conveying path 34 and is discharged to outside using a paper conveying path h1.

During duplex printing, first, it is necessary to reverse the paper after fixing while printing on one side of the paper. This is the same as explained for the image forming operation of the color printer 50. The switching unit 36 is then switched over to the position denoted by the solid line. The paper is therefore conveyed to the two-stage roller 101 using a paper conveying path h2. At this time, the two-stage roller 101 is rotated in the direction of an arrow P. The paper is then conveyed to a point of contact X of (the large diameter section 101b of) the two-stage roller 101 and the paper reversing auxiliary roller 103. The paper is then conveyed from the point of contact X in a discharge direction. When the vicinity of the trailing end of the paper reaches the point of contact X, the two-stage roller 101 is reversed in the direction Q. At the same time, the switching unit 36 is switched over to the position denoted by the virtual line. The paper then passes through the second conveying path 35 using a paper conveying path h3, is carried to the duplex conveying unit 26, and returns to an operation that prints the other side of the paper. There are also cases where the operation of conveying the returned paper back to a position where execution of a printing operation is possible again is repeated a number of times.

The returned paper is then conveyed back again to the position where printing is possible. Next, paper fed by the paper feed tray 17 (in this case, two pieces of paper) continues, and the returned paper (taken to be one sheet of paper here) is conveyed to the secondary transfer unit. The second sheet of paper is then conveyed to (the point of contact X with) the paper discharging/reversing roller 24 using the paper conveying path h2 after fixing. The previous piece of paper (second piece of paper) is in the process of being carried to the duplex conveying unit 26 at the time where the returned piece of paper (first piece of paper) is being conveyed to the paper discharging/reversing roller 24 by the fixing unit 23. The two-stage roller 101 is then rotated in the direction Q and the switching unit 36 is switched over to the position denoted by the virtual line. The paper (first sheet of paper) is then conveyed to a point of contact Y of (the small diameter section 101a of) the two-stage roller 101 and the paper discharge auxiliary roller 102 using the paper conveying path h1. The paper is then discharged to outside from the point of contact Y.

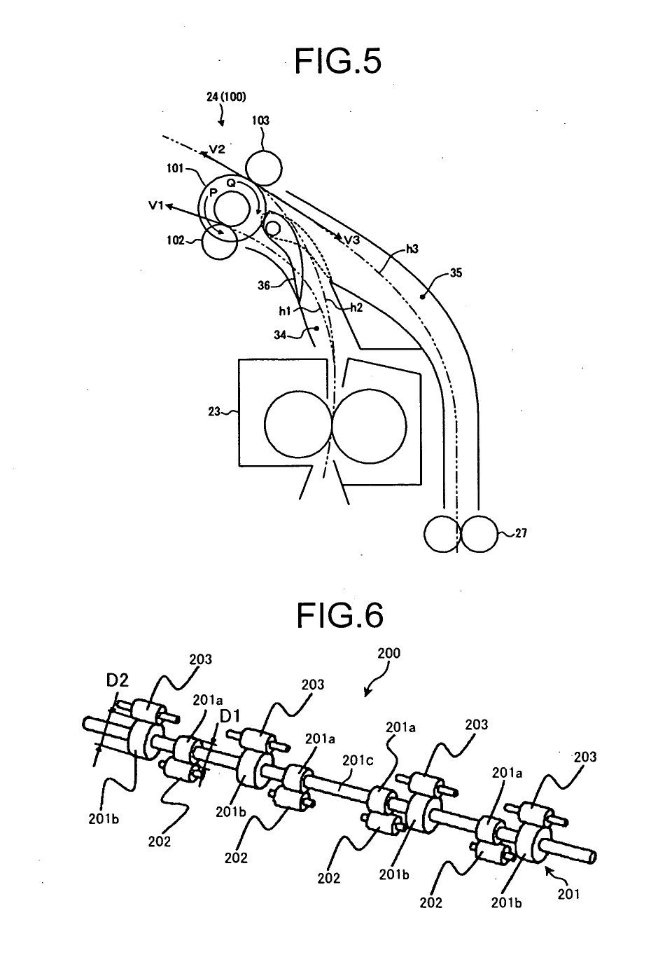

Next, drive control of the paper conveying device 100 (paper discharging/reversing roller 24) is explained with reference to FIG. 5. In the single-side printing operation, the paper is discharged from the fixing unit 23 using the paper conveying path h1. During this time, the two-stage roller 101 rotates in the direction of the arrow Q. However, the two-stage roller 101 is driven at a rotational speed N1 at this time. The paper is therefore sandwiched between the section of the two-stage roller 101 of the diameter D1 (small diameter section 101a) and the paper discharge auxiliary roller 102. The paper is then conveyed at a speed of V1=π·N1·D1. The conveying speed V1 is set so that paper discharged by the fixing unit 23 does not experience sagging or tensioning more that is necessary with respect to the conveying speed.

On the other hand, in the duplex printing operation (consecutive duplex printing), paper that is printed on one side continues, printing for one side concludes, and the paper is conveyed so as to be adjusted using a reversing operation in preparation for printing on the other side. The two-stage roller 101 is rotated in a direction P while paper printed on one side is conveyed from the fixing unit 23 using the paper conveying path h2. However, the two-stage roller 101 is driven at a rotational speed N2 at this time. The paper is therefore sandwiched between the section of the two-stage roller 101 of the diameter D2 (the large diameter section 101b) and the paper reversing auxiliary roller 103. The paper is then conveyed at a speed of V2=π·N2·D2.

When the trailing end of the paper printed on one side then reaches the two-stage roller 101, the two-stage roller 101 is reversed in the direction Q, while at the same time the switching unit 36 is shifted to the position of the virtual line. At this time, the two-stage roller 101 is driven at a rotational speed N1. As a result of this operation, the paper is carried to the duplex conveying unit 26 using the paper conveying path h3 at a conveying speed of V3=π·N1·D2. An operation of printing the other side of the paper is then returned. At the same time, paper that continued to be conveyed by the fixing unit 23 for which the printing operation for the other side is complete (duplex-printed paper) passes through the paper conveying path h1. The duplex-printed paper is then sandwiched between the section of the two-stage roller 101 of diameter D1 (small diameter section 101a) and the paper discharge auxiliary roller 102 and is discharged to outside at the speed V1=π·N1·D1.

As a result of the above operation it is possible to discharge and reverse the paper at the same time. However, if the rotational speed of the two-stage roller 101 is set to N2=(D1/D2)·N1, then V1=V2=π·N1·D1. It is therefore possible to make the conveying speed V1 of paper discharged from the fixing unit 23 and the conveying speed in the paper discharge direction intended for maintaining an appropriate relationship V2 equal (V1=V2) . It is also possible to make just the conveying speed V3 for reversing the paper fast by making D2>D1. In this example, the conveying speed V1 (and V2) is set to a speed ensuring that paper is not subjected to sagging or tensioning to a greater extent than is necessary with respect to the conveying speed of paper discharged by the fixing unit 23.

With the paper conveying device 100 of this example, portions of the drive roller are formed with different diameters (D1, D2) to increase productivity by making the conveying speed (V3) after reversing faster than the discharging speed (V1) while conveying after discharging and reversing two pieces of paper at the same time with a structure having three rollers (two driven rollers abutting with one drive roller) . Further, D1 is made less than D2, with discharging taking place using D1 (small diameter section) and reversing taking place at D2 (large diameter section).

The speed (V1) of discharging the paper to outside and the speed (V2) of conveying the paper in the discharge direction before reversing have to be the same because of the relationship with the fixing unit. However, D2 (the large diameter section) is used in conveying before reversing. The rotational speed is therefore controlled and V1=V2 is implemented. In this case, the relationship between the rotational speed and radius is taken to be N2=(D1/D2)·N1.

FIG. 6 is a perspective view showing a second embodiment of a paper conveying device that can be utilized as the paper discharging/reversing roller 24 of the color printer 50. The basic structure of a paper conveying device 200 of the second embodiment shown in the drawings is the same as the paper conveying device 100 of the first embodiment. In the first embodiment, the drive roller of the three rollers constituting the paper conveying device is a two-stage roller (101) having a small diameter section and a large diameter section. However, in the second embodiment, the drive roller is a pair roller constituted by a small diameter roller and a large diameter roller.

As shown in FIG. 6, a pair roller 201 has a small diameter roller 201a and a large diameter roller 201b fixed to a shaft 201c. In this example, four (four sets of) pair rollers 201 are fitted to the shaft 201c as the drive roller. The drive roller (pair roller 201) can be rotated both forwards and in reverse by a drive source (not shown). A paper discharge auxiliary roller 202 abuts with the small diameter roller 201a of the pair roller 201. The paper reversing auxiliary roller 103 abuts with the large diameter roller 201b. The paper discharge auxiliary roller 202 and the paper reversing auxiliary roller 103 are then rotated by the pair roller 201. A diameter of the small diameter roller 201a of the pair roller 201 is D1 and is the same as the diameter of the small diameter section 101a of the two-stage roller 101 in the first embodiment. A diameter of the large diameter roller 201b of the pair roller 201 is D2 and is the same as the diameter of the large diameter section 101b of the two-stage roller 101 of the first embodiment. The paper discharge auxiliary roller 202 is the same as the paper discharge auxiliary roller 102 of the first embodiment. The paper reversing auxiliary roller 103 is the same as the paper reversing auxiliary roller 103 of the first embodiment.

The operation when the paper conveying device 200 of the second embodiment used as the paper discharging/reversing roller 24 of the color printer 50 is the same as the case for the paper conveying device 100 in the first embodiment and is not explained.

The configuration of parts is simplified and the costs are reduced in the paper conveying device 200 of the second embodiment by using the pair roller 201 having the small diameter roller 201a and the large diameter roller 201b of a simple shape as the drive roller of the three rollers constituting the paper conveying device rather than using a two-stage roller.

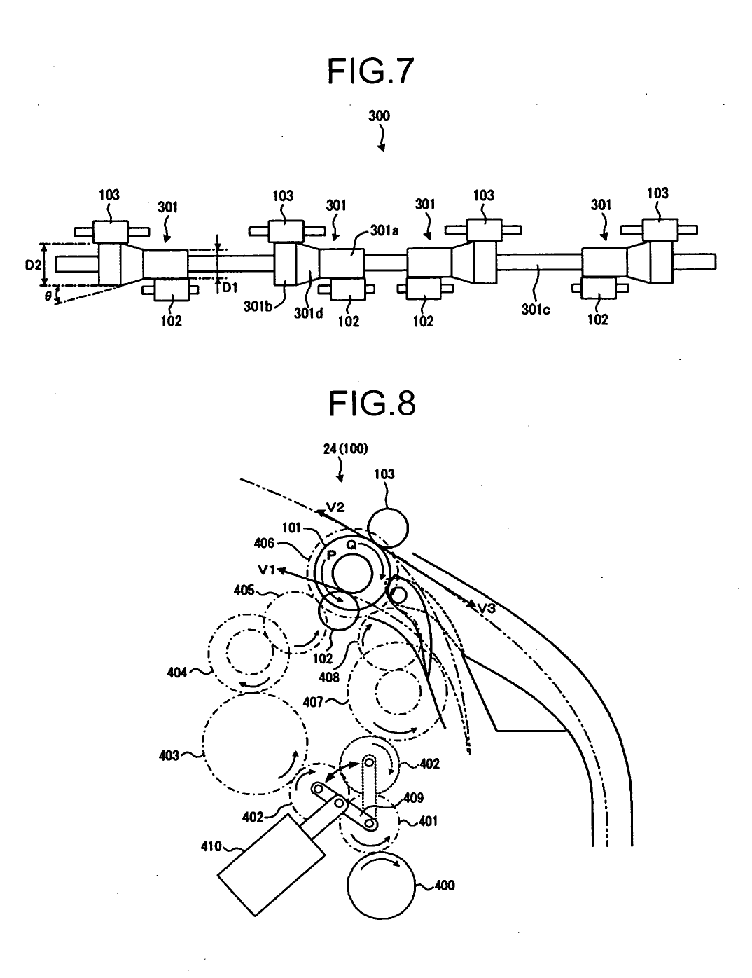

FIG. 7 is a side view of a third embodiment of a paper conveying device that can be utilized as the paper discharging/reversing roller 24 of the color printer 50. A paper conveying device 300 of the third embodiment adopts a two-stage roller 301 where a tapered section 301d is provided between a small diameter section 301a and a large diameter section 301b as a drive roller of the three rollers constituting the paper conveying device. Other aspects of the configuration are substantially the same as for the paper conveying device 100 of the first embodiment. The paper discharge auxiliary roller 102 abuts with the small diameter section 301a of the two-stage roller 301. The paper reversing auxiliary roller 103 abuts with the large diameter section 301b. The paper discharge auxiliary roller 102 and the paper reversing auxiliary roller 103 are then rotated by the two-stage roller that is the drive roller. The diameter of the small diameter section 301a of the two-stage roller 301 is D1 and is the same diameter as the small diameter section 101a of the two-stage roller 101 of the first embodiment. The diameter of the large diameter section 301b of the two-stage roller 301 is D2 and is the same diameter as the large diameter section 101b of the two-stage roller 101 of the first embodiment. The two-stage roller 301 can be rotated both forwards and in reverse by a drive source (not shown).

The operation when the paper conveying device 300 of the third embodiment is used as the paper discharging/reversing roller 24 of the color printer 50 is the same as the case for the paper conveying device 100 in the first embodiment and is not explained.

It is possible to suppress deformation such as bending of the paper at the paper conveying device 300 of the third embodiment by providing the tapered section 301d between the small diameter section 301a and the large diameter section 301b of the two-stage roller 301. A taper angle (angle with respect to a roller axis) θ of the tapered section 301d is preferably set to thirty degrees or less.

For example, at the paper conveying device 100 of the first embodiment, the paper also comes into contact with the large diameter section 101b of the two-stage roller 101 while conveyed sandwiched by (the small diameter section 101a of) the two-stage roller 101 and the paper discharge auxiliary roller 102. At the paper conveying device 200 of the second embodiment, the paper also comes into contact with the large diameter roller 201b of the pair roller 201 while conveyed sandwiched by (the small diameter roller 201a of) the pair roller 201 and the paper discharge auxiliary roller 202. It is therefore possible that deformation of the paper such as bending can occur as a result of the stepped portion of the two-stage roller 101 or the differences in diameter of the pair roller 201. However, it is possible to suppress deformation such as bending of the paper at the paper conveying device 300 of the third embodiment by providing the tapered section 301d between the small diameter section 301a and the large diameter section 301b of the two-stage roller 301.

An explanation is given in the three embodiments of a paper conveying device of the present invention. In each embodiment, the relationship of the discharging speed V1, the speed V2 of conveying before reversing, and the speed V3 of conveying after reversing of the drive rollers 101 (202, and 301) is V1=V2<V3. An explanation is also given where the rotational speed of the drive roller 101 (201, and 301) during discharging and during conveying after reversing are controlled to be N1 and N2 respectively to implement V1=V2. It is possible to achieve this difference in rotational speed by controlling the rotational speed of a drive source (for example, a motor) that drives the drive roller 101 (201, 301). However, it is also possible to achieve V1=V2 by fixing the rotational speed of the drive source (or a rotating member driven by the drive source) and switching over between two drive transmission paths having different reduction ratios. In the following, an explanation is given of an example configuration where two drive transmission paths having different reduction ratios are switched between.

FIG. 8 is an enlarged diagram of the vicinity of a discharging/reversing unit and shows an example drive system for when a paper conveying device of any one of the first to third embodiments is used as the paper discharging/reversing roller 24 of the color printer 50. An explanation is given using the paper conveying device 100 of the first embodiment as the paper discharging/reversing roller 24. The three rollers constituting the paper conveying device are the drive roller of the two-stage roller 101, and two driven rollers of the paper discharge auxiliary roller 102 and the paper reversing auxiliary roller 103.

In the drive system of the example shown in the drawings, drive force is transmitted to the two-stage roller 101 by a drive source or by a rotating member 400 driven by a drive source (not shown) using drive transmission means such as gears depicted as dotted-and-dashed circles in the drawing. Dashed lines are shown in the drawing as virtual lines only depicting when a rotary gear 402 moves. A link member 409 is fitted to a shaft of a gear 401 above the rotating member 400. The rotary gear 402 is then axially supported at the other end (free end) of the link member 409. The two gears 401 and 402 then constitute a pendulum gear. An arm of a switching unit 410 such as a solenoid is then fitted to the center of the link member 409. The rotary gear 402 of the pendulum gear then moves between a position (first position) depicted by an alternate dotted and dashed lines and a position (second position) depicted by a virtual line (dashed line) as a result of operation/non-operation of the switching unit 410.

When the rotary gear 402 is switched over to the first position shown by the alternate long and short dash line in the drawing, a transmission gear 403 is arranged so as to mesh with the rotary gear 402. Drive force is then transmitted from the transmission gear 403 via a two stage gear 404 and a transmission gear 405 to a drive dear (gear installed at the shaft of the two-stage roller 101) 406 (this transmission path is referred to as a first path). When the rotary gear 402 is switched over to the second position shown by the virtual line (dashed line) in the drawing, a two stage gear 407 is arranged so as to mesh with the rotary gear 402. Drive force is then transmitted from the two stage gear 407 via a transmission gear 408 to the drive dear 406 (this transmission path is referred to as a “second path”). In this example, a transmission path for a second system that is a drive force transmission system from the rotating member 400 to the two-stage roller 101 is provided. When the rotating member 400 is rotated at a fixed rotational speed N in a clockwise direction in the drawing so as to be driven using the first path, the two-stage roller 101 rotates in the, direction of an arrow Q. The two-stage roller 101 is rotated in the direction of an arrow P when driven using the second path.

The two transmission gears 405 and 408 meshing with the drive gear 406 have different reduction ratios η1 and η2. The two-stage roller 101 is therefore driven at different speeds and in different directions when driven by the first path and the second path. In this example, the conveying speed the paper is discharged at after the completion of duplex printing is V1=π·N/η1·D1. The conveying speed before the paper is reversed V2=π·N/η2·D2. The conveying speed after reversing the paper V3=π·N/η1·D2. By then setting η2=(D2/D1)·η1, then V1=V2=π·N/η1·D1. It is then possible to make the speeds V1 and V2 that are conveying speeds in the discharge direction of the paper equal to maintain an appropriate relationship for the paper conveying speed. It is also possible to make just the conveying speed V3 the paper is reversed at fast by making D2>D1.

It is also possible to provide the switching unit 36 switching the paper conveying path in unison with the switching of the pendulum gear (movement of the rotary gear 402) using the switching unit 410 so as to move between a position denoted by a solid line and a position denoted by a virtual line.

The present invention is explained using examples in the drawings but the present invention is not limited. For example, in each of the embodiments, a drive roller with four of the two-stage rollers 100 and 300, or the pair rollers 200 on one shaft (drive shaft) is adopted but the number of rollers is not limited to four and can be an arbitrary number. The orientation etc. of each roller can also be set as appropriate. The diameter of each roller (the diameter of the large diameter section and the small diameter section, or the diameter of the large diameter roller and the small diameter roller) and the rotational speed of the drive roller can also be set as appropriate to give a desired conveying speed. The structure for driving the drive roller can also be designed as appropriate.

Appropriate structures can also be adopted for switching structures and switching units etc. when switching of the rotational speed of the drive rollers is implemented by switching drive systems. The reduction ratio of each drive system can also be appropriately set so as to obtain the desired conveying speed.

The structure of the image-forming section of the image forming apparatus is also arbitrary as is the order of arrangement of image-forming units for each color in a tandem method. This is also not limited to a tandem method, and arranging a plurality of developing apparatus so as to surround one photosensitive member or using revolver-type developing apparatus is also possible. The sheet conveying device of the present invention can also be applied to a full-color machine using toner for three colors, a multiple-color machine using toner for two colors, or a monochromatic apparatus. The image-forming apparatus is not limited to a printer, and can also be a copier, a facsimile, or a multifunction product having a plurality of functions.

The sheet conveying device is also not limited to paper conveying device of an image forming apparatus and can also be broadly applied to machines where sheet-shaped material is conveyed in a plurality of directions at the same time.

According to an aspect of the present invention, it is possible for a plurality of sheet to be conveyed in different directions at the same time. In this event, the conveying speeds of each sheet-shaped member are different. It is therefore possible to convey the sheet efficiently. When the present invention is applied to a discharging/reversing roller of, for example, an image forming apparatus, it is then possible to raise productivity during duplex printing.

Furthermore, according to another aspect of the present invention, it is possible to implement a roller-shaped rotating member using a simple structure. Conveying at different speeds in a plurality of directions is also possible. According to the present invention, it is possible to suppress deformation such as bending of sheet due to a difference in diameter between the small diameter section and the large diameter section.

Moreover, according to another aspect of the present invention, it is possible to suppress deformation of paper and to appropriately convey the sheet. According to the present invention, it is possible to implement the roller-shaped rotating member using simpler members and it is possible to convey in a number of directions at different speeds at the same time.

Furthermore, according to another aspect of the present invention, it is possible to set the sheet conveying speed of one auxiliary rotating member and the other auxiliary rotating member in the same direction to be the same during forward rotation and reverse rotation of the roller-shaped rotating member. When, for example, the present invention is then applied to a discharging/reversing roller of an image forming apparatus, it is possible to set the discharging speed and the conveying speed before reversing to be equal to maintain an appropriate relationship with the conveying speed from the fixing unit.

Moreover, according to another aspect of the present invention, when two drive transmission path systems that transmit driving force to the roller-shaped rotating member are provided and the drive transmission paths of the two systems can be switched over, it is possible to set the sheet conveying speeds due to the one auxiliary rotating member and the other one auxiliary rotating member in the same direction to be the same during forward rotation and reverse rotation of the roller-shaped rotating member. When, for example, the present invention is then applied to a discharging/reversing roller of an image forming apparatus, it is possible to set the discharging speed and the conveying speed before reversing to be equal to maintain an appropriate relationship with the conveying speed from the fixing unit.

Furthermore, according to another aspect of the present invention, it is possible to make the conveying speed fast when the sheet is conveyed in the reverse direction by using the large diameter portion of the roller-shaped rotating member. For example, when the present invention is applied to the discharge/reversing roller of an image forming apparatus, it is possible to make just the conveying speed after reversal fast.

Moreover, according to another aspect of the present invention, a plurality of sheet can be conveyed in different directions at the same time. In this case, the conveying speed is different for each sheet-shaped member. It is therefore possible to convey the sheet efficiently.

Furthermore, according to another aspect of the present invention, it is possible to discharge the sheet to outside using the roller-shaped rotating member and it is possible to reverse the conveying direction. According to the present invention, it is possible to improve productivity during duplex printing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sheet conveying device configured to convey a sheet in different directions at a time, comprising:
a roller-shaped rotating member that is rotated by a driving force from a drive unit; and
a plurality of auxiliary rotating members including a first auxiliary rotating member and a second auxiliary rotating member, abutting at different positions in a circumferential direction of the roller-shaped rotating member, wherein
the roller-shaped rotating member is configured to rotate in a forward direction and a reverse direction,
a diameter of a first portion of the roller-shaped rotating member where the first auxiliary rotating member abuts and a diameter of a second portion of the roller-shaped rotating member where the second auxiliary rotating member abuts are different from each other, and
a conveying speed of a sheet conveyed in a first nip formed by the first auxiliary rotating member and the roller-shaped rotating member and a conveying speed of a sheet conveyed in a second nip formed by the second auxiliary rotating member and the roller-shaped rotating member in different directions at a time are different from each other.

2. The sheet conveying device according to claim 1, wherein the roller-shaped rotating member is formed with a two-stage roller including a small diameter section and a large diameter section.

3. The sheet conveying device according to claim 2, wherein the two-stage roller further includes a tapered section between the small diameter section and the large diameter section.

4. The sheet conveying device according to claim 3, wherein an angle of the tapered section with respect to a rotational axis of the roller-shaped rotating member is equal to or smaller than 30 degrees.

5. The sheet conveying device according to claim 1, wherein the roller-shaped rotating member is formed with a pair of rollers including a small diameter roller and a large diameter roller.

6. The sheet conveying device according to claim 1, wherein a first rotational speed of the roller-shaped rotating member in the forward direction and a second rotational speed of the roller-shaped rotating member in the reverse direction satisfy
N2=(D1/D2)·N1
where N1 is the first rotational speed, N2 is the second rotational speed, D1 is the diameter of the first portion, and D2 is the diameter of the second portion.

7. The sheet conveying device according to claim 1, wherein
two drive transmission paths are provided for transmitting the driving force to the roller-shaped rotating member in different directions, including a first system and a second system,
a reduction ratio of the first system and a reduction ratio of the second system satisfy
η2=(D2/D1)·η1
where η1 is the reduction ratio of the first system, η2 is the reduction ratio of the second system, D1 is the diameter of the first portion, and D2 is the diameter of the second portion, and
the sheet conveying device further comprises a switching unit that switches over between the first system and the second system.

8. The sheet conveying device according to claim 6, wherein the diameter of the second portion is larger than the diameter of the first portion.

9. The sheet conveying device according to claim 7, wherein the diameter of the second portion is larger than the diameter of the first portion.

10. An image forming apparatus comprising a sheet conveying device that includes
a roller-shaped rotating member that is rotated by a driving force from a drive unit; and
a plurality of auxiliary rotating members including a first auxiliary rotating member and a second auxiliary rotating member, abutting at different positions in a circumferential direction of the roller-shaped rotating member, wherein
the roller-shaped rotating member is configured to rotate in a forward direction and a reverse direction,
a diameter of a first portion of the roller-shaped rotating member where the first auxiliary rotating member abuts and a diameter of a second portion of the roller-shaped rotating member where the second auxiliary rotating member abuts are different from each other, and
a conveying speed of a sheet conveyed in a first nip formed by the first auxiliary rotating member and the roller-shaped rotating member and a conveying speed of a sheet conveyed in a second nip formed by the second auxiliary rotating member and the roller-shaped rotating member in different directions at a time are different from each other.

11. The image forming apparatus according to claim 10, wherein the sheet conveying device is a sheet discharging/reversing roller that discharges a sheet to outside in a first mode and reverses a conveying direction of the sheet in a second mode.

12. The image-forming device according to claim 11, wherein in the second mode, the sheet of which the conveying direction is reversed by the sheet discharging/reversing roller is fed to a duplex conveying unit that reverses a recording side of the sheet.
